(19) United States
(12) Patent Application Publication
(10) Pub. No.: US 2015/0113601 A1
(43) Pub. Date: Apr. 23, 2015

(54) ESTABLISHING TRUST BETWEEN PROCESSOR AND SERVER

(71) Applicants: Luis E Luciani, JR., Tomball, TX (US); Christopher Davenport, Houston, TX (US)

(72) Inventors: Luis E Luciani, JR., Tomball, TX (US); Christopher Davenport, Houston, TX (US)

(21) Appl. No.: 14/397,316

(22) PCT Filed: May 31, 2012
(86) PCT No.: PCT/US2012/040217

§ 371 Date: Oct. 27, 2014

(51) Int. Cl. H04L 29/06

(52) U.S. Cl. CPC H04L 63/10
USPC 726/4

(57) ABSTRACT

Systems, methods, and machine-readable and executable instructions are provided for establishing trust between a management processor and a management server. Establishing trust between a management processor and a management server can include establishing trust between a scanning device and the management server by scanning a server code on a management server using a scanning device. Establishing trust between a management processor and a management server can include establishing trust between the scanning device and the management processor by scanning a processor code on a management processor using the scanning device. Establishing trust between a management processor and a management server can include creating a secure channel between the management server and the management processor through the scanning device. Establishing trust between a management processor and a management server can include establishing trust between the management server and the management processor through the secure channel.

### BACKGROUND

A data center can include a number of different systems that perform a number of many different tasks. Systems within a data center may be monitored from various locations. Some systems may be monitored and/or managed to gather information about the systems. A management server can monitor and/or manage a number of systems by requesting and receiving information from the number of systems.

### BRIEF DESCRIPTION OF THE DRAWINGS

FIG. 1 is a diagram illustrating an example of establishing trust between a number of management processors and a management server according to the present disclosure.

FIG. 2 is a flow chart illustrating an example of a method for establishing trust between a management processor and a management server according to the present disclosure.

FIG. 3 illustrates an example computing device according to an example of the present disclosure.

### DETAILED DESCRIPTION

Establishing a trust relationship can include a compromise between scalability and security. A trust relationship can be established between a server and a number of computers, e.g., computing devices. A trust relationship can be formed to allow a server to trust a number of messages from a number of computers and the number of computers to trust a number of messages from the server. A trust relationship between a server and a computer can be established when a server logs into another computer and/or when a computer logs into the server. A trust relationship can enable a server, e.g., management server, to manage the number of computers remotely. The server may manage the number of separate computers through a number of processors, e.g., a number of management processors, that are installed in the number of computers. A trust relationship between a server and a number of computers can also include a trust relationship between a server and a number of management processors within the number of computers. The number of management processors can provide the management server with information regarding the number of computers. The number of management processors can provide a management server with control over the number of computers. The trust relationship between a management server and a number of management processors can enable a network administrator, e.g., a user that manages the number of computers and the number of management processors within the number of computers, to manage the number of computers from a central location. The central location can be a management server.

Scalability can include the ability to establish a number of trust relationships. For example, scalability can include the ability of a management server to establish a trust relationship with multiple management processors and/or a scanning device. Security includes the ability of a management server to establish a trust relationship in a secure mariner.

It can be desirable to provide for the efficient establishment of a trust relationship between a management server and a management processor as the number of management processors increases and as access to each of the management processors is configured independently. Increasing efficiency can provide for scalability. Lowering the time involved and streamlining the process to establish a trust relationship improves efficiency and scalability. Maintaining a high level of security can include complexity in establishing a trust relationship and can require a longer time to establish a trust relationship than a less secure alternative. In a number of examples of the present disclosure, a trust relationship can be more efficiently established while maintaining a high level of security.

Previous approaches to establishing a trust relationship can include assigning a generic identification, e.g., generic user name, and a generic password, e.g., generic security token, to a number of management processors. Assigning a generic user name and a generic password can provide for a high level of scalability at the expense of security. A generic username and a generic password can provide for a high level of scalability because a management server can use the same generic username and/or generic password to establish a trust relationship with a number of management processors. A generic user name and/or a generic password can compromise security because generic user names and generic passwords can easily be accessed by the public.

For example, in previous approaches, a network administrator can establish a trust relationship between a management server and a number of management processors by physically accessing and retrieving from a computer a generic user name and a generic password. The network administrator can then configure a management server with the generic user name and the generic password by providing the management server with the generic user name and the generic password. In this previous approach, the management server can use the generic user name and the generic password to establish the trust relationship with the number of different management processors. A generic user name and a generic password can allow a management server to establish a number of relationships of trust without requiring the network administrator to approach each of the number of computers individually. That is, the generic user name and the generic password can provide for a high level of scalability because the network administrator provides the management server with a generic user name and a generic password that can be used for the number of different management processors. However, the generic user name and password can be a security liability because a third party that obtains the generic user name and the generic password can have access to the number of management processors.

Previous approaches to establishing a trust relationship can also include assigning a unique user name and a unique password to a number of management processors. Assigning a unique user name and a unique password can hinder scalability while promoting security. A unique user name and/or a unique password can hinder scalability because a network administrator may have to access each of the management processors to gather the unique username and unique password and return to the management server to establish the trust relationship between the management server and each respective management processor.

Using a number of unique user names and a number of unique passwords can provide a higher level of security than using generic user names and generic passwords because a third party cannot access all of the number of different management processors after obtaining just a particular unique user name and a unique password. However, there is no secure channel between the management server and the number of management processors because the unique user names and the unique passwords can still be accessed by a third party that has access to the physical location where the number of computers are stored.

In a number of examples of the present disclosure, a trust relationship can be established between a management processor and a management server through a secure channel. The secure channel can be provided through a scanning device that can scan a number of codes that correspond to the management server and the number of different management processors. The secure channel can provide security while the scanning device and the number of codes can provide a high level of scalability.

For example, a program instruction can be executed on a scanning device to scan a server code and a number of processor codes. The network administrator can approach a management server and request that the management server produce a server code. The management server can produce the server code, The network administrator can scan the server code with a scanning device. The scanning device can be a smart phone. The network administrator can approach a number of computers and scan a number of processor codes that can be located on the housing of the number of computers. The scanning device can use the server code to establish a trust relationship with the management server. The scanning device can use the processor code to establish a trust relationship with a number of management processors. The scanning device can function as a secure channel that allows a management server to trust a number of management processors and a number of management processors to trust a management server.

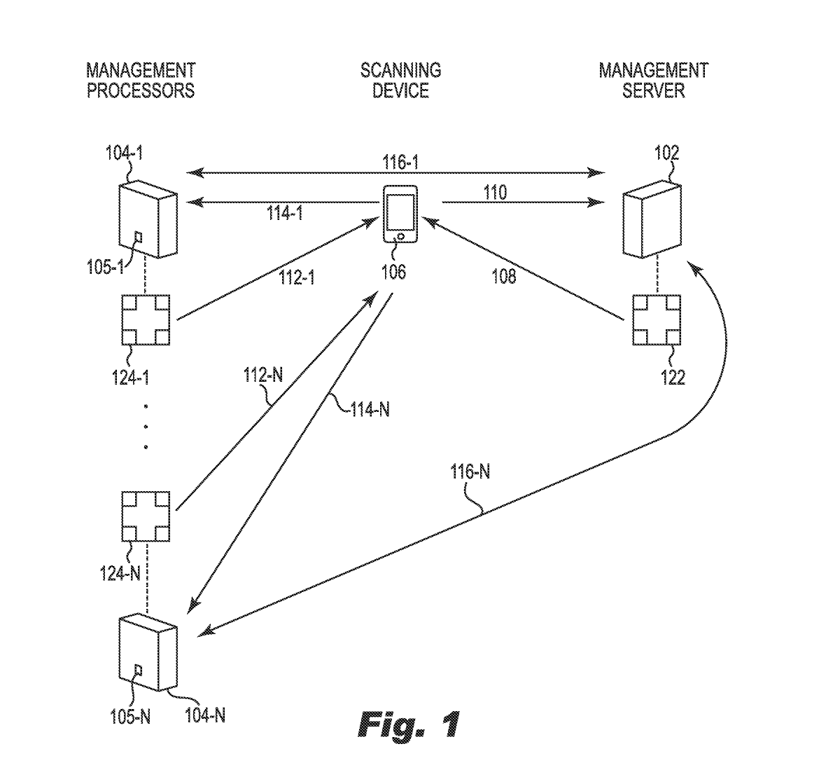

FIG. 1 is a diagram illustrating an example of establishing trust between a number of management processors and a management server according to the present disclosure. Each computing device can include a management processor. Trust can be established through a scanning device 106, e.g., smart phone, that is capable of scanning a server code 122 and a number of processor codes 124-1, . . . , 124-N. A server code 122 can correspond to a management server 102. A number of processor codes 124-1, . . . , 124-N can correspond to a number of management processor 105-1, . . . , 105-N.

A management server 102 can manage a number of computing devices 104-1, . . . , 104-N by managing a number of management processors 105-1, . . . , 105-N in the computing devices 104-1, . . . , 104-N, respectively. A management server 102 can include computer executable instructions (CRI), e.g., program instructions, and/or circuitry including logic in the form of an application specific integrated circuit (ASIC). As used herein, the designator “N”, particularly with respect to reference numerals in the drawings, indicates that a number of the particular feature so designated can be included. Furthermore, while only one management server 102 is illustrated in the example of FIG. 1, embodiments may include more than one management server 102.

A management processor can include circuitry including logic in the form of an application specific integrated circuit. A number of management processors 105-1, . . . , 105-N can be integrated in a number of computing devices 104-1, . . . , 104-N. The management processors 105-1, . . . , 105-N can allow an administrator to manage a number of functions of the computing devices remotely. The management processors 105-1, . . . , 105-N can manage the computing devices 104-1, . . . , 104-N regardless of whether the computing device is powered on or powered off. For example, a management processor can manage a power-on state of a computing device and a power-off state of the computing device remotely.

A scanning device 106 can scan 108 a server code 122 and/or a number of processor codes 124-1, . . . , 124N. A scanning device 106 can communicate with a management server 102 and/or a number of management processors 105-1, . . . , 105-N. The communication can include a wireless connection with a management server 102 and/or a wireless connection with a number of management processors 105-1, . . . , 105-N. The communication can also include a physical connection with a management server 102 and/or a physical connection with a number of management processors 105-1, . . . , 105-N. A communication, e.g., a number of messages, between a scanning device 106 and a management server 102 and/or a scanning device 106 and a number of management processors 105-1, . . . , 105-N can include a number of communication formats. Communication formats can include secure formats and non-secure formats.

A scanning device 106 can be a multipurpose scanning device, e.g., smart phone. A multipurpose scanning device can include other functions than scanning a code and connecting to a number of management processors 105-1, . . . , 105-N and/or a management server 102. For example, a multipurpose scanning device can include the ability to make phone calls and/or take pictures. A scanning device 106 can be a smart phone. In a number of examples of the present disclosure a scanning device 106 can include a portable scanning device. A portable scanning device can include a device that is designed to allow a user to move the scanning device to a number of locations in hand.

A server code 122 and a number of processor codes 124-1, . . . , 124-N can be provided via a number of code formats. For example, a server code 122 and/or a number of processor codes 124-1, . . . , 124-N can be provided as a universal product code (UPC), e.g., barcode, and/or a quick response (QR) code, among others. A server code 122 and/or a number of processor codes 124-1, . . . , 124-N can be used to establish a relationship of trust with a management server 102 and/or a number of management processors 105-1, . . . , 105-N, respectively. A server code 122 can include a server universally unique identifier (UUID), a server security token, and/or a server network address that correspond to a management server 102. A server UUID can uniquely identify a management server 102. A server security token can function as a password or a security secret that allows a management server 102 to trust a scanning device 106 and/or a number of management processors 105-1, . . . , 105-N. A server network address can correspond to a management server 102. Each of the processor codes 124-1, . . . , 124-N can include a processor UUID and/or a processor security token that correspond to a number of management processors 105-1, . . . , 105-N, respectively. A processor UUID can identify a management processor. A processor security token can allow a management processor to trust a scanning device 106 and/or a management server 102.

A processor security token and/or a system security token can be encrypted. A security token can be encrypted using a number of hash functions and/or encryption schemes. An encrypted security token provides an added level of security versus non-encrypted security tokens. In a number of examples of the present disclosure, a security token may not be encrypted.

A number of processor codes 124-1, . . . , 124-N can be provided for corresponding management processors 105-1, . . . , 105-N prior to deployment of the management processors 105-1, . . . , 105-N. For example, a number of processor codes 124-1, . . . , 124-N can be printed on a medium that can be attached to a housing of the corresponding management processors 105-1, . . . , 105-N. A number of processor codes 124-1, . . . , 124-N can be printed directly on a housing that houses a number of corresponding management processor 105-1, . . . , 105-N. A number of processor codes 124-1, . . . , 124-N can be identified with a number of corresponding management processors 105-1, . . . , 105-N in ways other than through a housing. For example, a processor code can be created, provided to a display, and displayed on a computer screen and/or through other mediums.

A server code 122 that corresponds to a management server 102 can be provided upon request by a verified user. For example, a user that wants to create a trust relationship between a number of management processors 105-1, . . . , 105-N and a management server 102 can log into a management server 102 and request a server code 122. As part of the server code 122, the management server 102 can create and/or provide a server UUID, a server security token, and/or a server network address. For example, a server UUID, a server security token, and/or a server network address can be incorporated into a server code 122 that can be presented to a user through a monitor, through a printout of the server code 122, and/or through other means. A server code 122 can change over a period of time as the network address of the management server 104 changes and/or as a security protocol for providing a server UUID and/or a server security token changes.

A scanning device 106 can scan a server code 122 that a management server 102 provides. A scanning device 106 can extract server login data, e.g., server UUID, server security token, and/or server network address, from a server code 122 and use the server login data to establish a relationship of trust 110 with a management server 102. A scanning device 106 can establish a relationship of trust 110 by providing the server UUID and the server security token to the management server 102 at the server network address. Establishing a relationship of trust 110 between a scanning device 106 and a management server 102 can allow a management server 102 to receive data regarding a number of managing processors 105-1, . . . , 105-N from the scanning device 106 and/or can allow a management server 102 to make a number of requests from the scanning device 106.

The scanning device 106 can scan 112 a number of processor codes 124-1, . . . , 124-N that correspond to a number of management processors 105-1, . . . , 105-N. The scanning device 106 can extract the processor login data, e.g., processor UUID and processor security token, from the number of processor codes 124-1, . . . , 124-N. The scanning device 106 can establish a relationship of trust 114 with a number of management processors 105-1, . . . , 105-N by providing the corresponding processor login data to the number of management processors 105-1, . . . , 105-N. Establishing a relationship of trust 114 between a scanning device 106 and a number of management processors 105-1, . . . , 105-N can allow the management processors 105-1, . . . , 105-N to receive and/or answer requests from the scanning device 106.

In a number of examples of the present disclosure, a scanning device 106 can be a secure channel, e.g., secured wireless channel, between a management server 102 and a number of management processors 105-1, . . . , 105-N. A secure channel can include the scanning device 106 receiving a number of server messages from the management server 102. The scanning device 106 can accept the number of server messages because the management server 102 trusts the scanning device 106 and the scanning device 106 trusts the management server 102. The scanning device 106 can send a number of server messages to a number of management processors 105-1, . . . , 105-N. The management processors 105-1, . . . , 105-N can accept the number of server messages from the scanning device 106 because the management processors 105-1, . . . , 105-N trust the scanning device 106 and because the scanning device 104 trusts the management processors 105-1, . . . , 105-N.

The management processors 105-1, . . . , 105-N can send a number of processor messages to a scanning device 106 in response to receiving the number of server messages from the scanning device 106. The scanning device 106 can send the processor messages to the management server 102. The management server 102 can trust the management processors 105-1, . . . , 105-N because the management server trusts the scanning device 106 and because the scanning device 106 trusts the management processors 105-1, . . . , 105-N. The management processors 105-1, . . . , 105-N can trust the management server 102 because the management processors 105-1, . . . , 105-N trust the scanning device 106 and because the scanning device 106 trusts the management server 102.

In a number of examples of the present disclosure, a scanning device 106 can provide a management server 102 with the processor login data and the management processors 105-1, . . . , 105-N with the server login data. A management server 102 can use the processor login data to establish a number of relationships of trust 116-1, . . . , 116-N with a number of management processors 105-1, . . . , 105-N. The management processors 105-1, . . . , 105-N can use the server login data to establish a number of relationships of trust 116-1, . . . , 116-N with a management server 102.

Once a relationship of trust is established between a management server 102 and a number of management processors 105-1, . . . , 105-N, a management server 102 can send a number of server messages to the management processors 105-1, . . . , 105-N. The management processors 105-1, . . . , 105-N can accept the number of server messages because the management processors 105-1, . . . , 105-N trust the management server 102. The management processors 105-1, . . . , 105-N can send a number of processor messages to the management server 102. The management server 102 can accept the number of processor messages from the management processors 105-1, . . . , 105-N because the management server 102 trusts the management processors 105-1, . . . , 105-N.

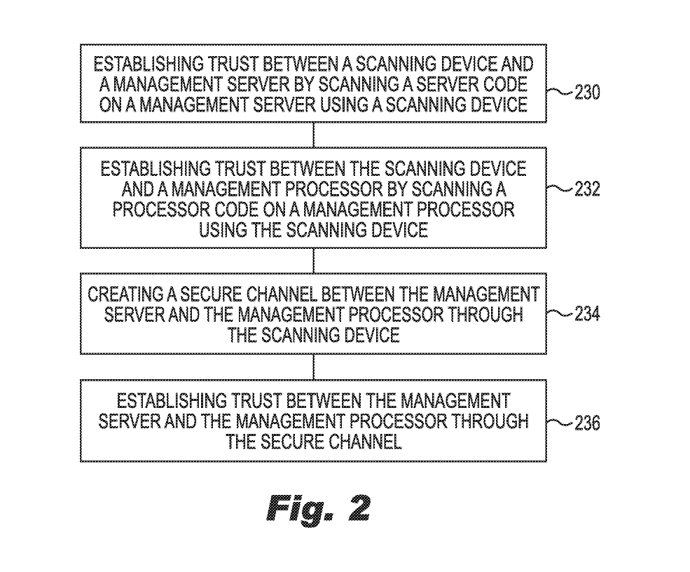

FIG. 2 is a flow chart illustrating an example of a method for establishing trust between a management processor and a management server according to the present disclosure. At 230, trust can be established between a scanning device and a management server by scanning a server code. At 232, trust can be established between the scanning device and a management processor by scanning a processor code. A server code can include a server UUID, a server security token, and a server network address. A processor code can include a processor UUID, a processor security token, and a processor network address. At 234, a secure channel can be created between the management server and the management processor through the scanning device. At 236, trust can be established between the management server and the management processor through the secure channel.

A server code can include a number of code formats. For example, a server code can include a QR code and/or a barcode. The server code can include server login data, e.g., server UUID, server security token, and server network address, that allows a scanning device and/or a management processor to log into a management server and establish a relationship of trust. The relationship of trust can be established by an authentication process that includes presenting a server UUID and a server security token to the management server that is located at the server network address. The authentication process that establishes a relationship of trust can allow a management server to trust a management processor. A processor code can include processor login data, e.g., processor UUID and processor security token, that allows a scanning device and/or a management server to log into the management processor and establish a relationship of trust. The relationship of trust can be established by an authentication process that includes presenting a processor UUID and a processor security token to the management processor. The authentication process that established a relationship of trust can allow a management processor to trust a management server.

In a number of examples of the present disclosure, a server UUID and a processor UUID can be unique UUID's. A server security token and a processor security token can be unique security tokens. A unique server UUID, a unique processor UUID, a unique server security token, and/or a unique processor security token can provide for an added level of security to a management processor and/or a management server.

The server UUID and the server security token can be provided to a management server through a wireless connection. The processor UUID and the processor security token can be provided to a management processor through a wireless connection. For example, a scanning device and/or the management processor can send the server UUID and the server security token to the management server through a wireless connection.

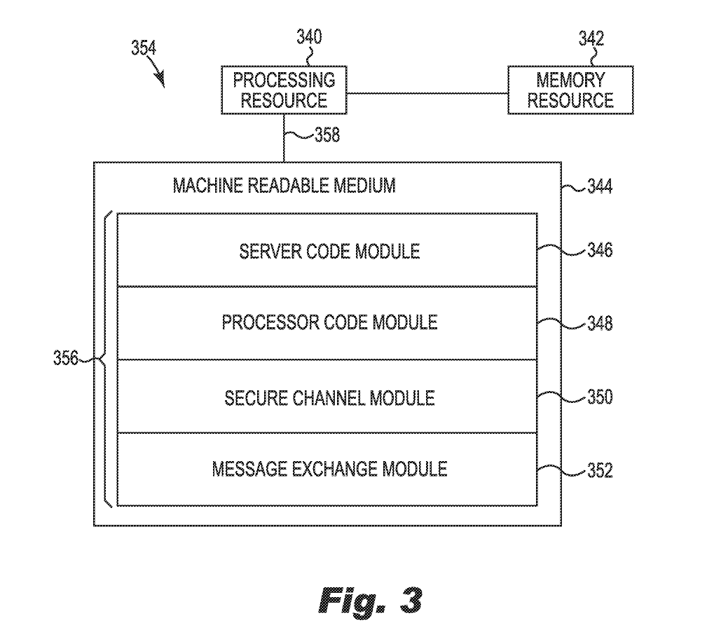

FIG. 3 illustrates an example computing device 354 according to an example of the present disclosure. The computing device 354 can utilize software, hardware, firmware, and/or logic to perform a number of functions.

The computing device 354 can be a combination of hardware and program instructions configured to perform a number of functions. The hardware, for example, can include one or more processing resources 340, machine readable medium (MRM) 344, etc. The program instructions, e.g., computer-readable instructions (CRI) 356, can include instructions stored on the MRM 344 to implement a desired function, e.g., establish trust between a management processor and a management server.

MRM 344 can be in communication with a number of processing resources of more or fewer than 340. The processing resources 340 can be in communication with a tangible non-transitory MRM 344 storing a set of CRI 356 executable by one or more of the processing resources 340, as described herein. The CRI 356 can also be stored in remote memory managed by a server and represent an installation package that can be downloaded, installed and executed. The computing device 354 can include memory resources 342 and the processing resource 340 can be coupled to the memory resource 342.

Processing resource 340 can execute CRI 356 that can be stored on internal or external non-transitory MRM 344. The processing resource 340 can execute CRI 356 to perform various functions, including the functions described in FIG. 1 and FIG. 2.

The CRI 356 can include a number of modules 346, 348, 350, and 352. The number of modules 346, 348, 350, and 352 can include CRI 356 that when executed by the processing resource 340 can perform a number of functions.

The number of modules 346, 348, 350, and 352 can be sub-modules of other modules. For example, the server code module 346 and the processor code module 348 can be sub-modules and/or contained within a single module. Furthermore, the number of modules 346, 348, 350, and 352 can comprise individual modules separate and distinct from one another.

A server code module 346 can comprise CRI 356 and can be executed by the processing resource 340 to establish trust between a scanning device and a management server by scanning a server code. A scanning device can scan a server code and present the server login data, e.g., server UUID and server security token, found in the server code to the management server to establish a relationship of trust with the management server. A relationship of trust can allow a management server to receive a number of messages from the scanning device.

A processor code module 348 can comprise CRI 356 and can be executed by the processing resource 340 to establish trust between a scanning device and a management processor by scanning a processor code. A scanning device can scan a processor code and present the processor login data, e.g., processor UUID and processor security token, found in the processor code to the management processor to establish a relationship of trust with the management processor. A relationship of trust can allow a management processor to receive a number of messages from the scanning device.

A secure channel module 350 can comprise CRI 356 and can be executed by the processing resource 340 to create a secure channel between the management server and the management processor through the scanning device. The secure channel can allow a first number of messages to travel from the management server to the management processor and a second number of messages to travel from the management processor to the management server.

A message exchange module 352 can establish trust between the management server and the management processor through the secure channel. A secure channel can allow a management processor to trust a number of messages that are sent from a management server through the scanning device because the management processor trusts the scanning device. A secure channel can also allow a management server to trust a number of messages that are sent from a management processor through the scanning device because the management server trusts the scanning device.

A non-transitory MRM 344, as used herein, can include volatile and/or non-volatile memory. Volatile memory can include memory that depends upon power to store information, such as various types of dynamic random access memory (DRAM) among others. Non-volatile memory can include memory that does not depend upon power to store information. Examples of non-volatile memory can include solid state media such as flash memory, electrically erasable programmable read-only memory (EEPROM), phase change random access memory (PCRAM), magnetic memory such as a hard disk, tape drives, floppy disk, and/or tape memory, optical discs, digital versatile discs (DVD), Blu-ray discs (BD), compact discs (CD), and/or a solid state drive (SSD), etc., as well as other types of computer-readable media.

The non-transitory MRM 344 can be integral or communicatively coupled to a computing device in a wired and/or wireless manner. For example, the non-transitory MRM 344 can be an internal memory, a portable memory, and a portable disk, or a memory associated with another computing resource, e.g., enabling CRIs 356 to be transferred and/or executed across a network such as the Internet.

The MRM 344 can be in communication with the processing resource 340 via a communication path 358. The communication path 358 can be local or remote to a machine, e.g., a computer, associated with the processing resource 340. Examples of a local communication path 358 can include an electronic bus internal to a machine, e.g., a computer, where the MRM 344 is one of volatile, non-volatile, fixed, and/or removable storage medium in communication with the processing resource 340 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof.

The communication path 358 can be such that the MRM 344 is remote from a processing resource, e.g., processing resource 340, such as in a network connection between the MRM 344 and the processing resource, e.g., processing resource 340. That is, the communication path 358 can be a network connection. Examples of such a network connection can include local area network (LAN), wide area network (WAN), personal area network (PAN), and the Internet, among others. In such examples, the MRM 344 can be associated with a first computing device and the processing resource 340 can be associated with a second computing device, e.g., a Java® server. For example, a processing resource 340 can be in communication with a MRM 344, wherein the MRM 344 includes a set of instructions and wherein the processing resource 340 is designed to carry out the set of instructions.

As used herein, “logic” is an alternative or additional processing resource to perform a particular action and/or function, etc., described herein, which includes hardware, e.g., various forms of transistor logic, application specific integrated circuits (ASICs), etc., as opposed to computer executable instructions, e.g., software firmware, etc., stored in memory and executable by a processor.

As used herein, “a” or “a number of” something can refer to one or more such things. For example, “a number of widgets” can refer to one or more widgets.

The above specification, examples and data provide a description of the method and applications, and use of the system and method of the present disclosure. Since many examples can be made without departing from the spirit and scope of the system and method of the present disclosure, this specification merely sets forth some of the many possible embodiment configurations and implementations.

What is claimed:

1. A method for establishing trust between a management processor and a management server comprising:
establishing trust between a scanning device and the management server by scanning a server code on the management server;
establishing trust between the scanning device and the management processor by scanning a processor code on the management;
creating a secure channel between the management server and the management processor through the scanning device; and
establishing trust between the management server and the management processor through the secure channel.

2. The method of claim 1, wherein establishing trust between the scanning device and the management server by scanning the server code includes the scanning device scanning the server code.

3. The method of claim 1, wherein establishing trust between the scanning device and the management processor by scanning the processor code includes the scanning device scanning the processor code.

4. The method of claim 1, wherein scanning the server code includes scanning a set of login data and a network address that correspond to the management server and the processor code includes a set of login data that corresponds to the management processor.

5. The method of claim 1, wherein establishing trust between the management server and the management processor through the secure channel includes the management server transmitting the processor code to the management processor and the management processor transmitting the server code to the management server.

6. A non-transitory computer-readable medium storing instructions for establishing trust between a management processor and a management server executable by a computer to cause the computer to:
receive a scanned server code that corresponds to the management server with a scanning device to establish trust between the scanning device and the management server;
receive a scanned processor code that corresponds to the management processor with the scanning device to obtain a set of processor login data of the management processor; and
send the set of processor login data to the management server to allow the management server to login to the management processor.

7. The medium of claim 6, wherein the server code includes a server universally unique identifier (UUID), a server security token, and a server network address that correspond to the server code.

8. The medium of claim 7, wherein establishing trust between the scanning device and the management server includes:
using the server UUID and the server network address to identify the management server and to establish a connection to the management server; and
using the server security token to establish trust with the management server.

9. A system for establishing trust between a management processor and a management server, comprising:
a server code that provides a set of server login data wherein the server code corresponds to the management server;
a processor code that provides a set of processor login data wherein the processor code corresponds to the management processor;
wherein the management processor receives the set of server login data and logs into the management server with the set of server login data; and
wherein the management server receives the set of processor login data and logs into the management processor with the set of processor login data.

10. The system of claim 9, wherein the management processor receives the set of server login data through a secured wireless connection and the management server receives the set of processor login data through the secured wireless connection.

11. The system of claim 9, wherein:
the server code is presented by the management server through a monitor that is connected to the management server upon a request by a scanning device; and
the processor code is provided on a processor housing that houses the management processor and is generated during a manufacturing process.

12. The system of claim 11, wherein the management server incorporates a server universally unique identifier (UUID), a server security token, and a server network address into the server code and display the server code on a monitor for the scanning device to scan.

13. The system of claim 11, wherein the processor code includes a unique processor UUID that identifies a management processor and a unique processor security token.

14. The system of claim 9, wherein the server code includes a server quick response (QR) code and the processor code includes a processor QR code.

15. The medium of claim 9, wherein the server code includes a server universal product code (UPC) and the processor code includes a processor UPC.
